(19) United States
(12) Patent Application Publication
(10) Pub. No.: US 2013/0202561 A1
(43) Pub. Date: Aug. 8, 2013

(54) METHOD OF TREATING DRAINS USING FUNGUS CULTURES

(71) Applicants: Vincent J. Scuilla, Sarasota, FL (US); Christopher J. Reuter, Parrish, FL (US); Lauren G. Danielson, Palmetto, FL (US)

(72) Inventors: Vincent J. Scuilla, Sarasota, FL (US); Christopher J. Reuter, Parrish, FL (US); Lauren G. Danielson, Palmetto, FL (US)

(73) Assignee: Osprey Biotechinc Inc., Sarasota, FL (US)

(21) Appl. No.: 13/386,946

(22) PCT Filed: May 12, 2010
(86) PCT No.: PCT/US10/01405

§ 371 Date: Mar. 23, 2012

(30) Foreign Application Priority Data
Jul. 27, 2009 (US) 12460962

(51) Int. Cl. A01N 63/04

(52) U.S. Cl. CPC A01N 63/04
USPC 424/93.3; 424/93.5

(57) ABSTRACT

A method of treating drain systems containing organic matter and providing a biopesticide for killing insects is provided. The method comprises introducing into a drain system a bacterial culture, such as Bacillus sp or Pseudomonas sp, which metabolizes the organic matter, and a biocidal amount of an entomopathogenic fungal culture, such as Metarhizium, which kills the insects such as cockroaches or other soft-bodied insects. The drain system can be a residential or commercial drain system. The bacterial culture and the fugal culture can be maintained separately and then mixed for the treating of the drain, or they can be maintained together prior to introducing them into the drain. The microorganism cultures are dispersed separately or together into the drain. The cultures can be dispersed as a spray, a powder, a liquid, or a foam.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

(1) Field of the Invention

The present invention relates generally to treating drains containing organic matter with biological material. In particular, the present invention relates generally to treating drains with bacteria and fungus to remove grease and kill insects.

(2) Description of Related Art

Blattella germanica (the German cockroach) and Periplaneta americana (the American cockroach) are ubiquitous throughout the world. They are the major insect pests in residences, restaurants, hospitals, dormitories and warehouses. Cockroaches are unsightly and have been implicated as vectors of several human disease agents. Cockroaches and other soft-bodied insects are known to populate drain systems. In particular, these insects are known to find habitat and populate commercial drain systems including commercial traps and waste holding containers.

The most common means of roach control is the regular spraying of chemical insecticides. Not only are these insecticides expensive, but their long term effects on the inhabitants of the places in which they are used, as well as the environment, are unknown in most cases and potentially hazardous. Further, there is a tendency among the treated insects for resistant strains to develop, which requires the use of large quantities and different chemicals to treat.

Insect pathogens are a possible alternative to the common use of highly toxic chemical insecticides for the control of insect pests. Fungi are one of the promising groups of insect pathogens suitable for use as biological agents for the control of insects.

Fungi are found either as single cell organisms or as multicellular colonies. While fungi are eukaryotic and therefore more highly differentiated than bacteria, they are less differentiated than higher plants. Fungi are incapable of utilizing light as an energy source and therefore restricted to a saprophytic or parasitic existence.

The most common mode of growth and reproduction for fungi is vegetative or asexual reproduction which involves sporulation followed by germination of the spores. Asexual spores, or conidia, form at the tips and along the sides of hyphae, the branching filamentous structures of multicellular colonies. In the proper environment, the conidia germinate, become enlarged and produce germ tubes. The germ tubes develop, in time, into hyphae which in turn form colonies.

The fungus Metarhizium anisopliae is an example of a fungus that infects certain species of insects. This fungus has been administered to insect pests by a number of methods, including direct spraying, injection, and by the application of the fungus to the plant material on which the insect lives or feeds. In some insect species, infection with the fungus has been shown to result in death. In one species, infected individuals were able to transmit the fungus to non-infected members of their colony.

Much of work evaluating entomopathogenic fungi for biological control of insect pests has focused on applications involving agriculturally important insect pests and mosquitoes. Metarhizium anisopliae is one of the most widely studied fungus for biological control of insects.

U.S. Pat. Nos. 5,057,315 and 5,310,552 to Gunner et al. disclose methods and devices for the biological control of cockroaches. Convenient, economical, non-toxic and effective methods and means for the control of roaches are provided by administration of entomopathogenic fungi to the cockroaches. In the preferred embodiment, the roaches are exposed to the fungi by means of a contamination chamber having openings through which the cockroaches enter and come in contact with a living culture of a fungus which is pathogenic to cockroaches. The fungal spores attach to the roach, germinate and penetrate into the body of the cockroach, resulting in the death of the infected roach. Death takes approximately two to three weeks after contact with the culture. During this time, the infected roach disseminates spores of the pathogenic fungus throughout the infested areas which may subsequently infect other roaches. Given the proper environmental conditions, the fungus sporulates on the cadaver of the roach and the conidia can be transmitted to other cockroaches, resulting in a further spread of the disease.

U.S. Pat. No. 5,427,784 to Gunner et al. provides for a device containing fungus for the biological control of insects. An infection chamber for control and extermination of insects, including roaches, flying insects such as the housefly, and other insects such as the adult form of the corn rootworm by infection of the insects with a fungus that can be pathogenic when administered to the insects in a sufficiently high concentration is provided. The chamber maintains the spores of a fungus pathogenic to the insects in a viable form, protecting the fungi from the environment (including rain, ultraviolet light and the wind), serves as an attractant for the insects, and serves to inoculate the insects with high numbers of spores. Although the primary means of infection is by external contact, the insects may also be infected by contact with each other and by ingestion of the spores. The two most preferred entomopathogenic fungi are Metarhizium anisopliae and Beauveria bassiana, although other fungi can be used which are pathogenic when the insect is inoculated via the infection chamber. Examples demonstrate control of Blattella germanica (the German cockroach), Periplaneta americana (the American cockroach, Fannia canicularis (little housefly), Musca domestica (housefly), and Diabrotica undecempunctata using chambers containing Metarhizium anisopliae and Beauveria bassiana.

Although methods and devices for killing insects using fungus are known, a need still remains for a suitable and effective method for distributing the fungus to drain systems to destroy the insects in those drain systems with a viable fungus without the need for dedicated containers.

U.S. Pat. No. 5,989,898 to Jin et al. discloses a method for storing fungal conidia. Methods for packaging Metarhizium fungal cultures or conidia are described. In one embodiment, the fungal culture is provided within an insect infection chamber that attracts insects, and then infects them with a lethal dosage of fungus, where the packaging maintains high humidity within the chamber, allows free exchange of gases, and is impermeable to microbes, including fungal spores, viruses, and bacteria. In a second embodiment, the fungal conidia are packaged under conditions which maintain high viability even after long-term storage at both 25° C. and 37° C., i.e., low relative humidity and oxygen. The conidia can then be reactivated for the use in the control of insects such as cockroaches, flies, ants, soft-bodied insects, turf pests, and caterpillars.

A further problem related to drainage systems, particularly in commercial drainage systems used in the food service industry is grease and waste build-up and accumulation. The drainage fluid created by the food industry contains a variety of substances which can generate clogs in the associated drainage system. In particular, where sugars and refrigerated water are present in the drainage fluid such as with drainage systems connected to beverage dispensers and ice bins, yeast tends to grow in the trap of the drain where the drain fluid collects. The constant source of water and sugar in the trap creates an ideal environment for yeast to grow. As the yeast grows, it forms long chains or ropes which clog the drainage system.

U.S. Pat. No. 6,558,538 to Scuilla et al. provides a method and device for preventing the formation of deposits in a drainage system. The device includes a container, connected by a flexible cord to a stopper. An antimicrobial composition is placed in the container and the container is inserted into a drain opening. The container moves to the bottom of the trap of the drainage system. The container is preferably located at least partially beneath the water or drainage fluid in the bottom of the trap. The cord and stopper prevent the container from moving beyond the trap. The cord and stopper allow for removal of the container from the drainage system, once the composition has been fully dispensed.

There remains the need for a device which allows an antimicrobial compound to be positioned in the trap of a drainage system or holding container of a drainage system for commercial systems to prevent the formation of deposits in the drainage system and which can be easily inserted and removed from the drainage system in combination with a method of killing pests such as cockroaches or other soft-bodied insects.

### OBJECTS

It is therefore an object of the present invention to provide a method for removing organic material from drain systems while providing a pesticide for killing insects in the drainage system.

These and other objects will become increasingly apparent by reference to the following description.

### SUMMARY OF THE INVENTION

The present disclosure provides for a method of treating a drain containing organic matter comprising grease. The method comprises (a) providing a processed bacterial culture which metabolizes the organic matter with a biocidal amount of a fungus culture for insects in the drain; and (b) introducing the cultures into the drain in a timed release to metabolize the grease and kill the insects. The drain can be a residential or commercial drain. The fungus can be intended to kill insects that are cockroaches or other soft-bodied insects. In a particular embodiment, the cultures can be separately sprayed into the drain. In a further embodiment, the cultures are dispersed together into the drain with the fungus. In an even further embodiment, the bacterial culture is a Bacillus sp or a Pseudomonas sp and the fungus is Metarhizium. The cultures can be maintained separately and then mixed for the treating of the drain. In a further embodiment, the cultures are maintained together prior to introducing them into the drain. The cultures can be dispersed as a spray. In a further embodiment, the cultures can be introduced as a powder into the drain. In an even further embodiment, the cultures are introduced as a liquid into the drain. In yet an even further embodiment, the cultures are introduced as a foam.

The present disclosure provides for a drain treatment composition which comprises a mixture of a bacterial strain or culture which metabolizes grease and a fungus culture which is a pesticide for insects in the drain. In a particular embodiment, the bacterial culture can be a Bacillus sp. or a Pseudomonas sp. The composition can be used to treat insects such as cockroaches or other soft-bodied insects. The composition can be dispersed as a spray. In a further embodiment, the composition can be introduced as a powder into the drain. In an even further embodiment, the composition is introduced as a liquid into the drain. In yet an even further embodiment, the composition is introduced as a foam. The fungus culture can be Metarhizium.

The present disclosure provides for a method of treating drains containing insects to be killed which comprises, introducing a biocidal amount of a fungus culture in the drain in a timed release to kill the insects. The method is operable to kill insects such as cockroaches and other soft-bodied insects. In a particular embodiment, the fungus culture is dispersed as a spray into the drain. In a further embodiment, it is introduced as a powder into the drain. In an even further embodiment, it is introduced as a liquid into the drain. In yet an even further embodiment, it is introduced as a foam into the drain. The fungus culture can be Metarhizium.

### BRIEF DESCRIPTION OF THE DRAWINGS

FIG. 1 illustrates an exemplary drainage system treatment device for use in a waste trap.

FIG. 2 illustrates an exemplary two component bag for holding and separately distributing fungi and bacterial cultures.

FIG. 3 illustrates an exemplary packing container for holding a plurality of the bags from FIG. 2.

FIG. 3A illustrates a magnified view of the bag of FIG. 3 to show the physical separation of the two sections.

FIG. 4 illustrates an exemplary waste trap with a spray device mounted therein.

FIG. 5 illustrates an exemplary spray device for distributing fungi and/or bacteria into the waste trap.

FIG. 6 illustrates a cross section of the spray device of FIG. 5 to show internal components as described in U.S. Pat. No. 5,964,403 to Miller et al.

FIG. 7 illustrates an alternative embodiment of the spray device for delivering the fungus and/or bacteria to the waste trap as described in U.S. Pat. No. 5,964,403 to Miller et al.

FIG. 8 illustrates an exemplary powder spray delivery schematic.

FIG. 9 illustrates an exemplary foam spray delivery schematic.

### DESCRIPTION OF PREFERRED EMBODIMENTS

All patents, patent applications, government publications, government regulations, and literature references cited in this specification are hereby incorporated herein by reference in their entirety. In case of conflict, the present description, including definitions, will control.

In the present disclosure, the term “microorganism” generally refers to any organism too small to be viewed by the unaided eye, as bacteria, protozoa, and some fungi and algae. Metarhizium fungus and bacteria cultures described hereinbelow are encompassed by the term “microorganism.” The term “drainage system” generally refers to any system of pipes and/or containers that can accumulate grease and has insects present, particularly cockroaches. Usually the drainage system comprises at least one sink and a trap.

A method of treating a drain containing organic matter comprising grease is disclosed. The method comprises the steps of introducing a bacterial culture into the drain system. The bacterial cultures should be introduced into particular portions of the drain system prone to undesired accumulation or growth of organic matter such as grease. The bacterial culture is capable of metabolizing the organic matter. The bacteria cultures should be suitably tolerant of fungus cultures, particularly Metarhizium fungus.

For a biological control agent to be effective at a practical level to control cockroaches, carpenter ants, and pharaoh ants, it is desirable that the agent not only exhibit pathogenicity against these pests, but also be virulent. The more virulent it is, the better it is as a biocontrol agent. Though some fungal isolates have been shown to have some pathogenicity to these pests, these isolates did not have the essential virulence to function as a biocontrol agent. Metarhizium has been found to be an effective biocidal fungus suitable to kill insects and spread to other insects through contract.

Like most entomogenous fungi, Metarhizium initiates infection by a germinating spore (conidium) attaching to and subsequently penetrating the cuticle of the insect host. Advantageously, the fungi isolate and attach very securely to the cuticle of cockroaches and ants and are typically not removed by the insect's grooming activities. This may account somewhat for the high virulence of the fungus. As the fungus penetrates the insect's cuticle, the invasive hyphae begin to enter the host's tissues and ramify through the hemocoel. Hyphal bodies or segments of the hyphae distribute throughout the hemocoel, filling the dying insect with mycelia. Emergence hyphae grow out through the insect's integument and produce spores on the external surface of the host. These spores, or conidia, are dispersed and capable of infecting new host insects. Spores can be dispersed within the nest by the activities of the pests.

The present disclosure provides for a bacterial culture introduced into a drainage system that is operable to metabolize organic matter containing grease. Typically, the bacterial culture is processed bacteria. In a particular embodiment, a biocidal amount of fungus culture is introduced into the drain to treat insects found in the drain system. Organic matter accumulation and insects can be found almost anywhere in the drain system including the trap. In a particular embodiment, the trap of the drainage system is treated with the bacterial culture and the fungus by introducing them into the trap. Drainage systems associated with sinks of commercial food service kitchens, i.e., restaurants, can be relatively large and further comprise a trap storage container that also tends to populate insects such as cockroaches. These areas of the commercial kitchens can also be treated by the fungus culture and even further treated with the bacteria culture adapted to metabolize the organic matter.

U.S. Pat. Nos. 5,057,315, 5,310,552, and 5,427,784, the subject matter of which are incorporated herein in their entirety, disclose methods of killing pests, particularly cockroaches, and the effectiveness of those methods using fungi. Particularly effective fungi are Metarhizium anisopliae and Beauveria bassiana. These patents disclose the presence of a physical infection chamber to deliver the fungus to the insects. The insects are attracted to the chamber, enter into the chamber and are thereby contacted with the spores of the fungi causing the desired infection of the insect. Once an insect is infected through contact with or ingestion of the fungi, it is capable of spreading it to others particular after it is killed.

Some Fungi are suitable insect pathogen for use as biological agents for the control of insects. The most common mode of growth and reproduction for fungi is vegetative or asexual reproduction which involves sporulation followed by germination of the spores. Asexual spores, including conidia, form at the tips and the sides of sporogenous cells on the hyphae, the branching filamentous structures of multicellular mycelium. In the proper environment, the conidia germinate, become enlarged, and produce germ tubes. The germ tubes develop, over time, into hyphae which in turn form mycelia. When the insect is inoculated via contact with the living propagules of the entomopathogenic fungi, the infection occurs as soon as the parasite relationship between the fungus and the target insect is established. With the development of infection, the fungus gradually kills the insect.

U.S. Pat. No. 5,989,898 to Jin et al., the subject matter of which is incorporated by reference herein in its entirety, discloses a method of preserving fungi, particularly Metarhizium or Beauveria. Packaging provides an environment that keeps the fungus alive thus maintaining its viability when introduced into drain system environments. Conidia may be packaged in bulk quantities under the appropriate conditions, and then suspended in a mixing tank for spray applications against pests. In this embodiment it may be desirable to include surface active agents that reduce the surface tension of fungal conidia to facilitate germination in an application vehicle without affecting the viability of the fungal conidia. After mixing the conidia with the application vehicle, the fully-formulated fungal agent is ready for application using conventional devices and methods for spraying onto areas to be treated for insect control.

In a particular embodiment, the fungi and the bacterial cultures are dried separately. The dried cultures are then mixed together. The mixture of the dried cultures reduces risk of the cultures adversely affecting each other. Moreover, a dried mixture is desired for shipping purposes. The dry mixture can then be formulated into an aqueous solution for aqueous application to drain systems on site. In a further embodiment, the cultures are mixed in an aqueous environment and maintained together in an aqueous environment. The fungi culture can be pretreated in order to maintain its viability in the aqueous environment. The fungi and the bacterial culture are then introduced into the drain system together.

The drain systems for application of a biocidal fungus can be residential or commercial drain systems. Insects such as cockroaches populate these drain systems including the trap of the drain systems. Some commercial drain systems comprise large trap holding containers that also can be treated by the biocidal fungus. The insects are typically cockroaches or other soft-bodied insects. Restaurants often employ large trap containers which attract cockroaches and other insects. The biocidal fungus is particularly useful in drain systems associated with kitchens of restaurants.

In an exemplary embodiment, the bacterial culture is sprayed into the drain via a storing and spraying means for maintaining the bacteria. The fungus is also sprayed into the drain via a storing and spraying means for maintaining the fungus. In a further embodiment, the bacterial cultures and the fungi are separately sprayed into the drain. In an even further exemplary embodiment, the bacterial cultures and the fungi are dispersed together into the drain. In a particular embodiment, the bacterial culture used in treating the drains is a Bacillus sp. or a Pseudomonas sp. These cultures are capable of metabolizing and thus reducing or removing organic matter from the drains. In particular, these cultures are operable in reducing or removing grease accumulation in drain systems.

The Metarhizium fungus is operable as a pesticide in the drain. When insects are exposed to the fungus through contact or ingestion, it is capable of contaminating other insects. If the insect returns to a colony, a significant amount of the colony will also be infected through the transportation of the fungus to their location. One infected host will spread the fungi to others. Accordingly, introducing the Metarhizium to the drain system, particularly the trap, will allow for desired exposure of the Metarhizium to the insects when the insects venture into those sections of the drain system. The fungus will spread to other insects when the infected host returns to their location.

Several methods of dispersion can be employed for introducing the bacterial cultures and fungi into the drain systems. In one embodiment, the cultures are dispersed as a spray. In a further embodiment, the cultures are introduced as a powder into the drain. In an even further embodiment, the cultures are introduced as a liquid into the drain. In yet an even further embodiment, the cultures are introduced as a foam. A composition comprising the Metarhizium fungus and the bacteria cultures can also be introduced into the drainage systems using various dispersion methods such as sprays, powders, liquids, and/or foam.

### EXAMPLES

U.S. Pat. No. 5,935,843 to Glendening et al., the subject matter of which is incorporated herein in its entirety, discloses a method and apparatus for waste degradation. The method deposits microorganisms that degrade waste into waste traps typically found in restaurant settings.

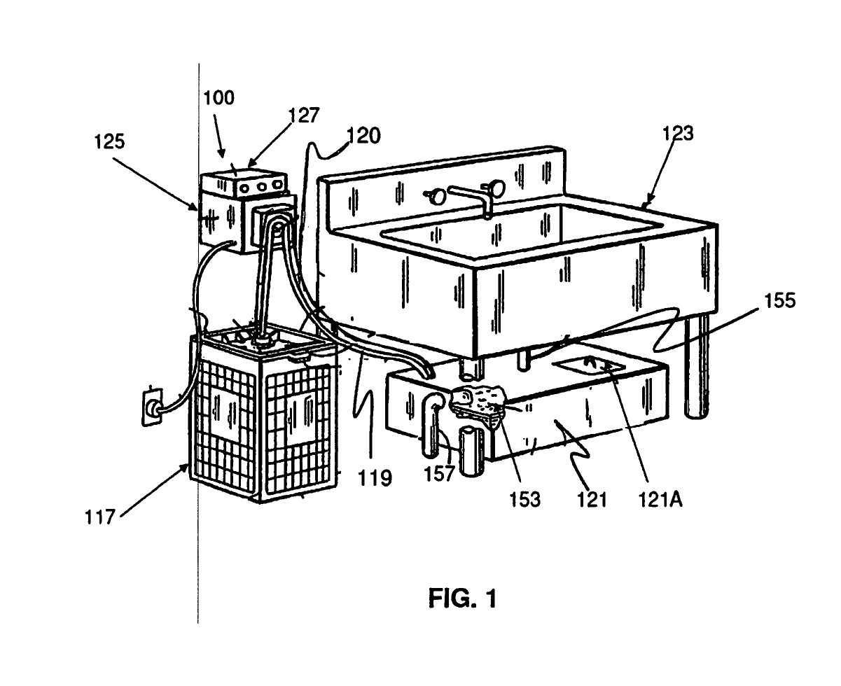

With reference to FIG. 1-3A of the present disclosure, a waste degradation system 100 is shown. The system 100 includes a bag 110 as a container for holding an aqueous solution 113 of microorganisms 115 supported in a crate 117 for the bag 110. Solution feed hoses 119 and 120 connect between the bag 110 and a waste trap 121 for a sink 123. A pump 125 having a timer 127 regulates the periodic flow of the microorganism solution 113 from the bag 110, through the hoses 119 and 120 and into the waste trap 121. The bag should be constructed of a material that allows for adequate oxygen exposure to maintain the viability of the spores of the fungus cultures. Generally, the fungus solution is dedicated to one hose 120 and the bacteria solution to the other hose 119. This creates physical separation of the two solutions. Moreover, the bag should allow for a suitable relative humidity in the bag to maintain the viability of the cultures.

The microorganisms 115 and 116 can be prepared using any known technique and dried. Typically, these microorganisms are bacteria operable to metabolize organic matter such as grease. Grease typically accumulates in the waste traps. In a particular embodiment, the microorganisms 115 and 116 are freeze-dried or lyophilized and held at reduced temperatures. Exemplary temperatures can be between about 32° F. and 59° F. (0° C. and 15° C.) (refrigeration temperatures) to preserve the microorganisms 115 and 116 viability prior to use. In a particular embodiment of the present disclosure, bag 110 comprises two physically separated sections 111 and 112 for holding bacteria on section and fungi in the other. The fungi can also be dried and stored. Both sections 111 and 112 are separated in order to not contaminate each other. Adding water to each section will create an aqueous solution in each section 111 and 112. Both the fungi and the bacteria can then be introduced into the waste trap 121 through hose 119.

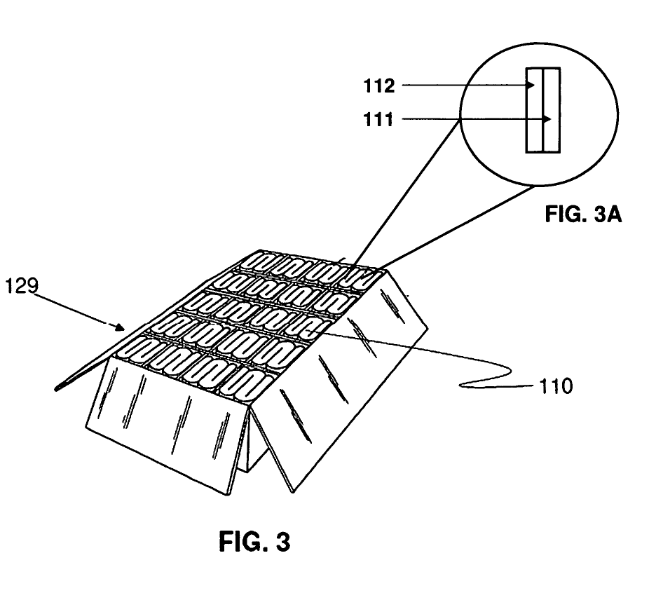

After the bacteria cultures 115 and fungi 116 have been concentrated and preserved (through known drying methods), the bacteria 115 and fungi 116 are placed in the bags 110 for later shipment. The dried microorganisms 115 and 116 can be stabilized to provide a longer life when water is added by using starch, sodium nitrate or other stabilizing agent. In an exemplary embodiment, as shown in FIG. 3, the bags 110 can be folded to minimize space and packaged in a shipping carton 129. In a particular embodiment, there are twenty (20) bags 110 per carton 129. As shown in FIG. 3A, the bags 110 include physically separated sections 111 and 112. If the microorganisms 115 and 116 are lyophilized, it is important that the carton 129 containing the bags 110 be stored in a freezer before use to maintain the microorganisms 115 and 116 in a viable state. Refrigerating the carton 129 can be done by any acceptable means. Carton 129 can be packed in dry ice or shipped in a refrigerated shipping container (not shown). Typically, Microorganisms 115 and 116 preserved by air drying can be held at room temperatures.

Certain microorganisms can be light sensitive and thus die faster when exposed to light. Bags 110 can thus be made of a flexible, plastic material such as polypropylene, which is opaque or translucent to reduce the amount of light reaching the microorganisms.

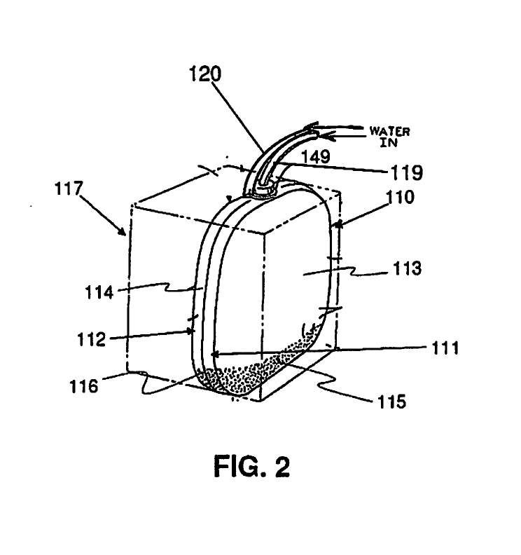

In an exemplary embodiment, for use in a restaurant, a bag 110 containing the microorganisms 115 and 116 is first placed in the crate 117, as shown in FIG. 2. The crate 117 is constructed to allow access through plug 149 and feed hose 119. Bag 110 should be suspended in crate 117 through a connection with plug 149 to allow for filling of the water into the bag. Introducing water into the two sections 111 and 112 of bag 110 activates the bacteria 115 and fungi 116. Once water is introduced, the aqueous solution 113, containing the bacteria, and an aqueous solution 114 containing the fungi are formed.

As shown in FIG. 2, the aqueous solution 113 of the bacteria 115 is made by first suspending the bag 110 in the crate 117 with the filler plug 149. A filler hose is then inserted into the filler plug 149 to fill the bag 110 with water until the bag 110 expends to the confines of the inside of the crate 117. The water brings the microorganisms 115 and 116 to ambient temperature, which activates the microorganisms 115 from their lyophilized or air-dried state. In an exemplary embodiment, the water is preferably held at a temperature of between about 59° F. and 95° F. (15° C. and 35° C.). In a particular embodiment, bag 110 is capable of holding about 5 gallons (18.9 liters) of aqueous solution, which can last about two (2) to four (4) weeks, primarily because of the need to maintain the viability of the microorganisms at room temperatures. The solution can last up to 30 days depending upon what stabilizing agent is used.

In a particular embodiment, as shown in FIG. 1, the crate 117 supporting the bag 110 containing the microorganisms in solution, along with the feed line 119, the peristaltic pump 125 and the timer 127 comprise the waste degradation system 100. The microorganisms 115 and 116 are particularly adapted to biodegrade liquid waste material 153 containing lipids or other hydrocarbons of the type that are typically discharged into the waste trap 121 such as is found in a restaurant or the like. Moreover, the fungal spores found in solution 116 are also present in waste trap 116 to expose insects to the spores. A biocidal amount of fungi should be introduced. A small amount of fungi is needed to infect a host insect which will thereby infect other insects it encounters. Waste 153 is usually placed in the sink 123 and flushed down the drain line 155 where the waste 153 collects in the waste trap 121. Therefore, to biodegrade the waste 153 so that the resulting solution can be drawn out of the waste trap 121 by a discharge line 157 and moved to a sewer system (not shown) without posing a pollution risk to the environment, the solutions 113 and 114 are periodically metered into the waste trap 121 containing the liquid waste material 153.

In an exemplary embodiment, before a metering process begins to deliver the solutions of bacteria and fungi, the waste trap 121 can be inoculated with an initial charge of the microorganisms 115 and 116. This is done by opening the trap lid 121A on the waste trap 121 and pouring a relatively large dosage of the microorganisms 115 into the waste trap 121. The liquid waste material 153 with the initial charge of microorganisms 115 and 116 is then agitated with a hoe or similar device. In a particular embodiment, the initial charge of microorganisms 115 and 116 can be between about seven (7) ounces (200 grams) of a mixed Pseudomonas culture containing 1×10¹² cells per gram. The purpose of introducing the initial charge of microorganisms into the waste trap 121 is to make sure that the initial liquid waste 153 present in the waste trap 121 is rendered free of lipids and other harmful hydrocarbons before the metering process of the aqueous solutions 113 and 114 into the waste trap 121 begins.

In a particular embodiment, the fungi can be introduced alone into waste trap 121. A single section or component of bag 110 can be used which contains the dried fungi 116. Water is added to generate an active aqueous solution and then introduced through a pump 125 coupled to a timer 127. The timer 127 can be programmable to deliver the solution at desired intervals. In a particular embodiment, a small amount of the solution 116 is introduced once per day. In a further embodiment, the solution 116 is introduced ever twelve hours. In an even further embodiment, solution 116 is introduced every hour. In yet an even further embodiment, the solution containing the fungus is introduced every thirty minutes. In yet an even further embodiment, the solution 116 is introduced very few minutes. In yet an even further embodiment, the solution is delivered continuously. The timing is programmable and these exemplary intervals are applicable to an embodiment containing both the fungus and the bacteria and the delivery of each microorganism. In an embodiment containing both bacteria and fungi, the delivery of each can be programmed to be delivered together or independent of each other.

The metering process is done at predetermined intervals or time periods to ensure that the waste material 153 in the waste trap 121 is continuously charged with a solution 113 and/or 114 of the microorganisms 115 and 116 in a concentration that is sufficient to degrade the liquid waste 153 and expose insects such as cockroaches sufficient to infect the insect or cockroach. The feed line 119 is preferably a flexible conduit made of a plastic material and connects to the peristaltic pump 125, which serves to move the solutions 113 and 114 from the bag 110 to the waste trap 121.

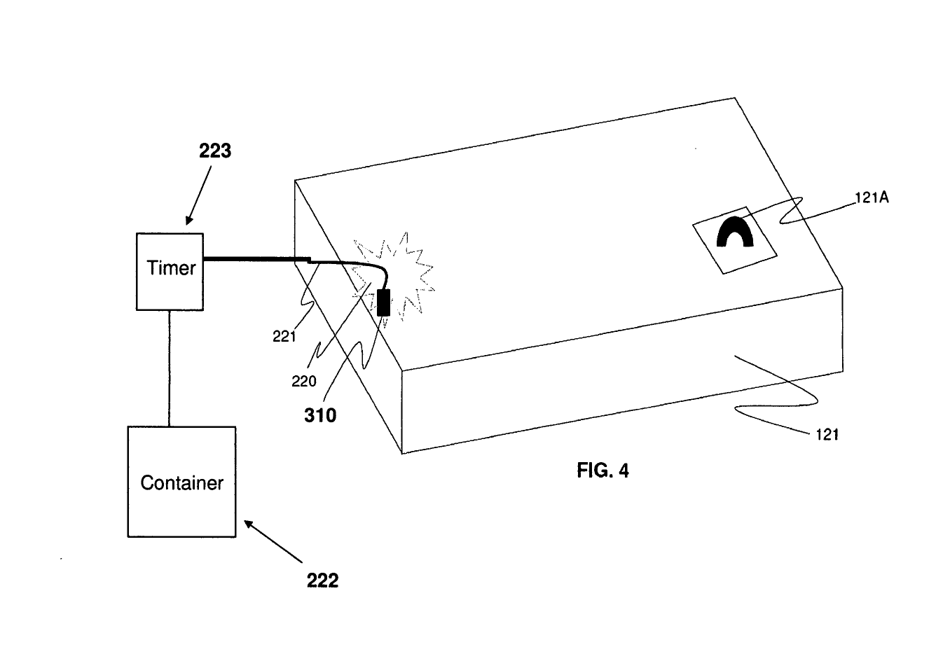

In a further exemplary embodiment, a spray application of the fungus is employed. The fungus can be contained in a canister or holding means connected to a programmable timing device 223 for automated delivery of the fungus to the waste trap. FIG. 4 illustrates an exemplary waste trap 121. Waste trap 121 can be similar to the waste trap 121 shown in FIG. 1 which comprises a trap lid 121A to allow for access to the interior of the trap 121. Purging the trap 121 is done through lid 121A. For illustrative purposes, a cut-out 220 is shown where an exemplary spray device 310 containing the desired fungi and optionally the bacteria can be removable mounted.

Device 310 can be mounted inside waste trap 121 by a mounting means 221 such as a hook or mounting wire. In one embodiment, spray device 310 hangs in trap 121 and releases a spray at timed intervals. Device 310 is coupled to a programmable timer unit 223 that delivers a message or signal to disperse at a desired interval of time. In a particular embodiment, the timer is connected to a container 222 containing the fungus and/or a mixture of fungus and bacteria to be delivered to the spray device 310. The timer unit 223 controls the amount and time of delivery through spray device 310. Typically, a tube or hose 221 connects spray device 310 to timer 223 and container 222.

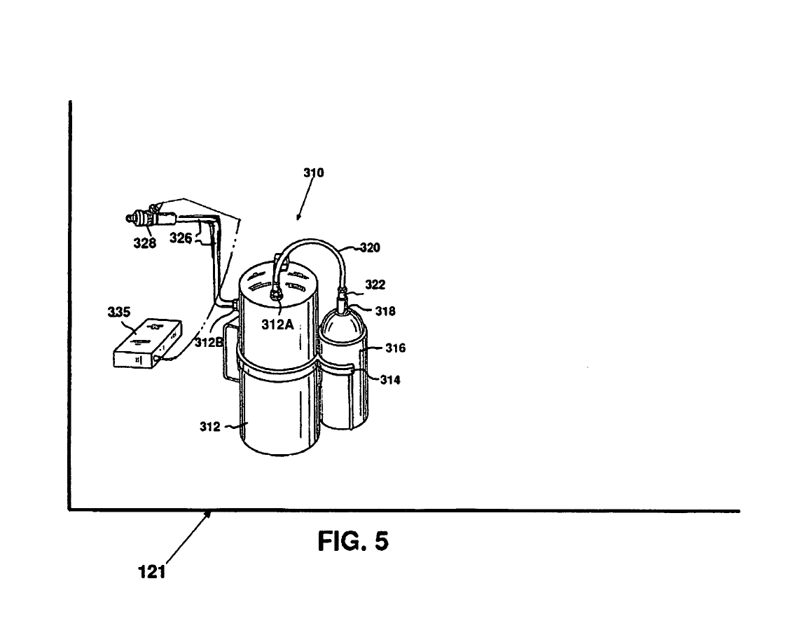

FIG. 5 illustrates an exemplary dispenser apparatus 310 for controlled and timed dispensing of a fungus and/or a fungus and bacteria mixture. Similarly to the liquid embodiment described hereinabove, the fungus and bacteria can be mixed together or contained in separate sections or compartments for individual delivery. The spray device comprises a sealed container means having an inlet and an outlet and which is configured to hold a pressurized gas; an adaptor means mounted on the inlet which allows the pressurized gas to be provided in the container means; a nozzle means connected to the outlet of the container means, wherein the nozzle means comprises: a body with a passage therethrough; a valve needle moveable in the passage of the body to open and close the passage; a solenoid coil with electrical leads, the coil which provides a continuous circuit surrounding the valve needle so that the needle is moved upon application of a current through the coil; and a bias means which holds the valve needle in a closed position when the current is not applied through the coil; and a control means which supplies current to the coil to move the valve needle against the bias means to open the passage in the body of the nozzle means and allows the fungus and/or bacteria to be dispensed periodically from the container means through the passage in the body of the nozzle means.

FIG. 5 shows an exemplary embodiment of the device 310 to be removable mounted in waste trap 121. The apparatus 310 includes a liquid storage container 312, a propellant container 316 and a control circuit (not shown). The liquid storage container 312 can be a standard liquid container having an inlet 312A and an outlet 312B. The inlet 312A allows for filling or refilling the container 312 with the liquid. In further embodiments, the container has internal storage compartments for storing a dry inactive fungus and a bacteria culture. In a further embodiment, container 312 is connected to a storage container external to trap 121. The dry components can be activated by adding liquid.

In a particular embodiment, the liquid and propellant are stored in separate containers. The liquid storage container 312 preferably has a bracket 314 which allows for removably mounting the propellant container 316 on the liquid storage container 312. The separate propellant container 316 enables the user to easily purchase and replace the propellant with commercially available propellant containers.

The liquid storage container 312, in one exemplary embodiment, can store about 32.0 ounces of the liquid containing the desired microorganisms. However, the size of the container 312 can be adjusted depending on the size of the area to be treated and the time period over which the device 310 is to operate. The storage container 312 is preferably constructed of an inert metal such as stainless steel, brass or aluminum.

The propellant container 316 can be a standard propellant container 316 having a single inlet/outlet 318 which allows the container 316 to be charged with the propellant. The inlet/outlet 318 is connected by an airtight hose 320 to the inlet 312A of the liquid storage container 312. In a particular embodiment, the hose 320 is flexible to allow for easier connecting and disconnecting of the containers 312 and 316. The inlet/outlet 318 of the propellant container 316 is provided with a shut off, one way check valve 322 which allows the propellant container 316 to be detached from the airtight hose 320 connected to the liquid storage container 312 without loss of propellant. In addition, the shut off, one way check valve 322 also prevents the liquid from the container 312 from entering the propellant container 316 and from escaping the liquid storage container 312 when the propellant container 316 is disconnected. In an exemplary embodiment, the propellant container 316 holds about 8.0 ounces of propellant. However, it is understood that the size of the propellant container 316 is directly related to the amount of liquid to be dispensed. The propellant can be either a gas or a liquid. In the preferred embodiment, the propellant is difluoroethane filtered to 0.1 micron; however, any other well known propellant can be used.

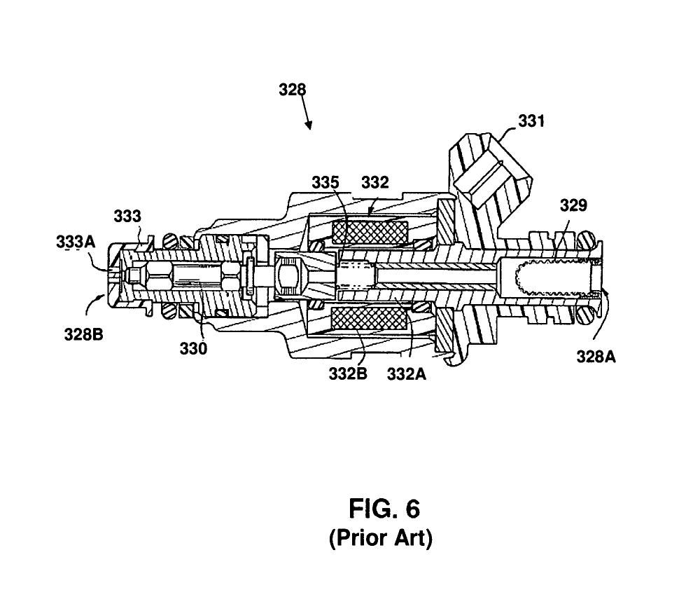

The outlet 312B of the liquid storage container 312 is connected by a second airtight hose 326 to an ejector nozzle 328. With reference to FIG. 6 (a prior art embodiment related to U.S. Pat. No. 5,964,403 to Miller et al.), the ejector nozzle 328 includes an inlet 328A having an integral filter 329, an electrical connector 331, a solenoid 332 having an armature 332A, a coil 332B and a valve mechanism with a valve needle or pintle 330. The inlet 328A of the ejector nozzle 328 is connected to the second airtight hose 326. The second hose 326, shown in FIG. 5, can be rigid such as to hold the ejector nozzle 328 in a fixed position spaced above the liquid storage container 312. Alternatively, the hose 326 can be slightly flexible to allow for positioning the ejector nozzle 328 in a certain direction. The ejector nozzle 328 is activated and controlled by a control circuit (not shown). The control circuit is connected to the electrical connector 331 of the ejector nozzle 328. The pintle 330 has a stainless steel body and which is moved into the “open” position by the solenoid 332 located in the base of the ejector nozzle 328. When the solenoid 332 is activated, the solenoid 332 moves the pintle 330 into the open position which allows the liquid and propellant in the ejector nozzle 328 and the second airtight hose 326 to be expelled from the ejector nozzle 328. The expulsion of the fungus places spores inside the waste trap 121. This embodiment operates as a spray for introducing the fungi into the waste trap 121. The spray provides particles of the fungus to cover a sufficient surface area to ensure that the insects will make contact and thus be infected with the fungus.

Once the solenoid 332 is deactivated, a spring 337 acts to move the pintle 330 into the “closed” position. When activated, the ejector nozzle 328 preferably ejects a stream of the liquid through the outlet 328B of the ejector nozzle 328. The outlet 328B of the ejector nozzle 328 can have a protection cap 333. The protection cap 333 can have at least one small orifice 333A which enables the ejector nozzle 328 to propel the liquid a greater distance in a stream. In an exemplary embodiment, the protection cap 333 has four orifices 333A. The amount of liquid delivered by the ejector nozzle 328 depends on how long the ejector nozzle 328 remains in the open position. The ejector nozzle 328 is preferably a pintle type injector similar to those used as fuel injectors for automotive vehicles. Alternately, a ball type injector or a disc type injector can be used. Controlling the pintle 330 of the ejector nozzle 328 allows a precise amount of the liquid to be ejected during one pulse. In the preferred embodiment, the ejector nozzle 328 is a fuel injector (port injection).

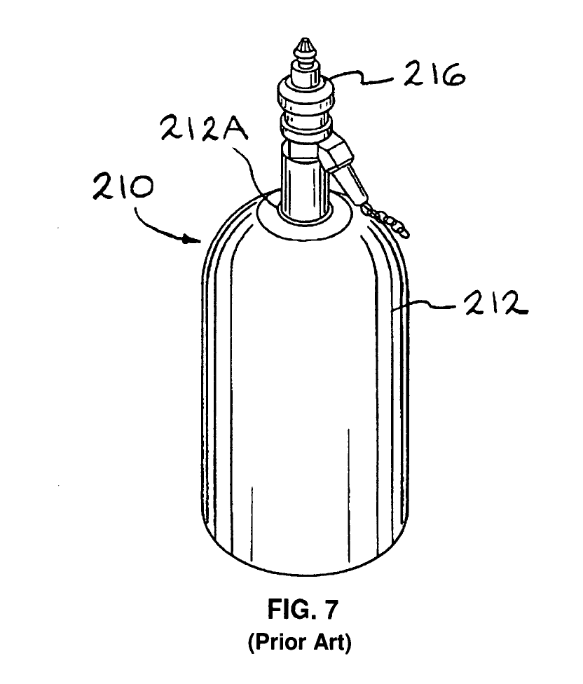

In an alternative prior art embodiment (related to U.S. Pat. No. 5,964,403 to Miller et al.) as shown in FIG. 7, the liquid and the propellant of the apparatus 210 are in the same container 212. The container 212 is preferably provided with an outlet 212A which allows for filling the container 212 with the liquid and the propellant. The container 212 is preferably able to be recharged with a propellant such as CO₂ or N₂. The outlet 212A is connected to an ejector 216. The ejector nozzle 216 is preferably similar to that used in the embodiment of FIGS. 5-6.

In the spray embodiments, the ejector nozzle 328 or 216 can be controlled by a control circuit coupled to an electronic control unit or timing unit as described with respect to FIG. 1. The circuit can be mounted in a weatherproof, watertight box 335 shown in FIG. 5, typically positioned outside the trap 121. In an exemplary embodiment, the control box 335 can be in wireless communication with a wireless processor unit (not shown) coupled to the spray device. In a further exemplary embodiment, the circuit uses a capacitor in combination with transistors and resistors to create a low power, timing circuit for activating and deactivating the ejector nozzle 328 of the apparatus 310 or 210. The control circuit typically includes a power source, a switch, a capacitor, a pair of transistors, and resistors. An LED can be provided in the circuit to indicate that the solenoid 332 has been activated by the circuit. Preferably, when the solenoid 332 is activated, the LED is flashed to clearly indicate that the apparatus 310 is functioning. In general, in the control circuit, when the capacitor has discharged, current is allowed to flow in the circuit which activates the solenoid 332 to “open” the valve 330 of the ejector nozzle 328 to dispense the liquid. When the capacitor is fully charged, the capacitor prevents current from flowing in the circuit and in the solenoid 332 which in turn deactivates the solenoid 332 of the ejector nozzle 328 or 216 which allows the spring to move the valve needle of the valve 330 of the ejector nozzle 328 or 216 into the “closed” or “off” position which causes the ejector nozzle 328 to stop dispensing the liquid.

Spray device 310 can be configured to release the fungus and/or the combination of the fungus with bacteria at similar time limitations previously described with respect to a liquid application. The fungus can be packed as a dried powder in the spray device or as an aqueous solution. If the fungus is dry, then water can be added to activate the fungus and provide a sprayable solution.

In alternative exemplary embodiments, the fungus can be delivered into the waste trap 121 as a foam or powder. In a powder embodiment, a fan or propellant can be used to disperse the powder particles into the trap 121. Alternatively, the powder is propelled through a spray mechanism.

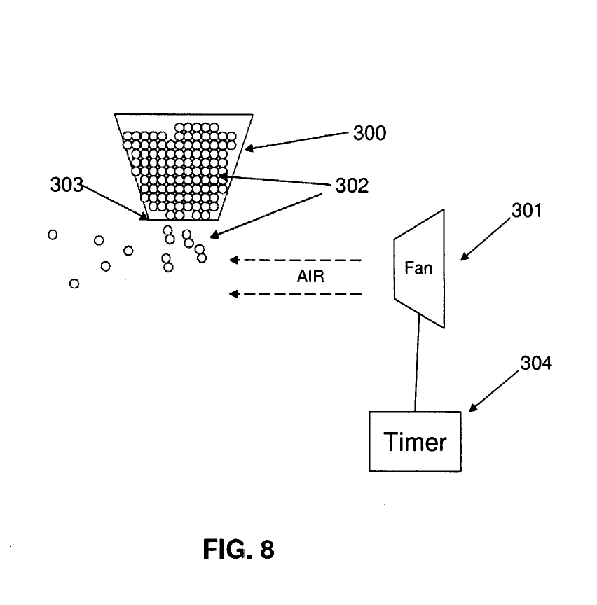

In a foam embodiment, a stabilizing means for ensuring the viability of the fungus can be added. In a further embodiment, an adhesive chemical can be added to the foam to ensure that the foam at least partially adheres to the surface of the trap 121. As shown in FIG. 8, a powder dispenser 300 can be employed with fan 301 for dispensing powder 302. The powder 302 can be released from an opening 303 of the dispenser 300 and then dispersed through an electronically controlled fan 301. The fan 301 can be coupled to a timer unit 304 for automated and preprogrammed activation of the fan 301 and powder dispenser 300.

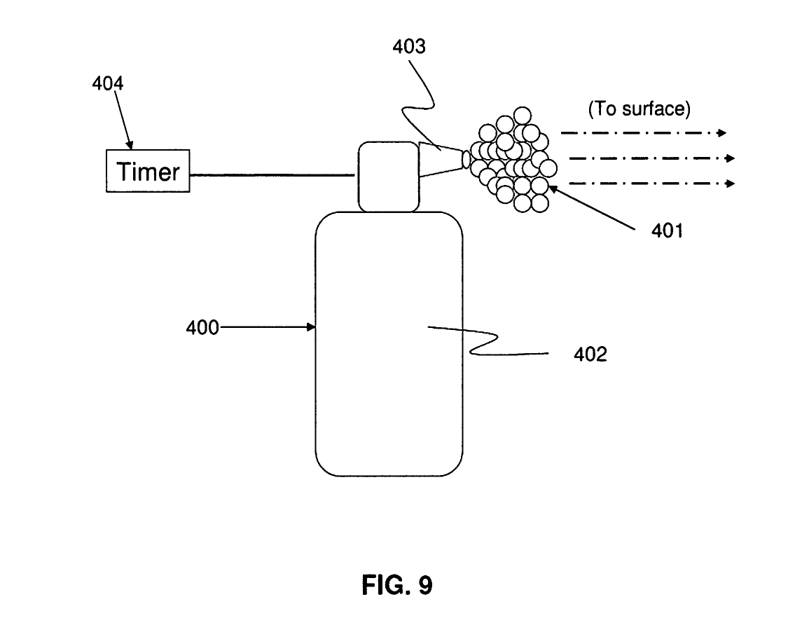

As shown in FIG. 9, a foam dispenser 400 is shown for dispensing foam 401 to the interior surface of trap 121. Foam dispenser 400 comprises a foam container 402 and a nozzle 403. These dispensers can also be coupled to a timing release means such as timer unit 404 for automated delivery of the fungus to the trap 121. Similar mounting means for mounting powder dispenser 300 and foam dispenser 400 as can be applied to the liquid and spray embodiments described hereinabove.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

1. A method of treating a drain containing organic matter comprising grease, which comprises:
(a) providing a processed bacterial culture which metabolizes the organic matter with a biocidal amount of a fungus culture for insects in the drain; and;
(b) introducing the cultures into the drain in a timed release to metabolize the organic matter and kill the insects.

2. The method of claim 1 wherein the drain is a residential or commercial drain.

3. The method of claim 1 or 2 wherein the insects are cockroaches or other soft-bodied insects.

4. The method of claim 1 or 2 wherein the cultures are separately dispersed into the drain.

5. The method of claim 1 or 2 wherein the cultures are dispersed together into the drain.

6. The method of claim 1 or 2 wherein the bacterial culture is a Bacillus sp or a Pseudomonas sp and the fungus is Metarhizium.

7. The method of claim 1 or 2 wherein the cultures are maintained separately and then mixed for the treating of the drain.

8. The method of claim 1 or 2 wherein the cultures are maintained together prior to introducing them into the drain.

9. The method of claim 1 or 2 wherein the cultures are dispersed as a spray.

10. The method of claim 1 or 2 wherein the cultures are introduced as a powder into the drain.

11. The method of claim 1 or 2 wherein the cultures are introduced as a liquid into the drain.

12. The method of claim 1 or 2 wherein the cultures are introduced as a foam.

13. A drain treatment composition which comprises a mixture of a bacterial strain or culture which metabolizes grease and a fungus culture which is a pesticide for insects in the drain.

14. The composition of claim 13 wherein the bacterial strain or culture is a Bacillus sp. or a Pseudomonas sp.

15. The composition of claim 13 wherein the insects treated by the composition are cockroaches or other soft-bodied insects.

16. The composition of claim 13 wherein the composition is introduced into the drain as a spray.

17. The composition of claim 13 wherein the composition is introduced as a powder into the drain.

18. The composition of claim 13 wherein the composition is introduced as a liquid into the drain.

19. The composition of claim 13 wherein the composition is introduced as a foam into the drain.

20. The composition of claim 13 wherein the fungus culture is Metarhizium.

21. A method of treating drains containing insects to be killed which comprises, introducing a biocidal amount of a fungus culture in the drain in a timed release to kill the insects.

22. The method of claim 21 wherein the insects are cockroaches and other soft-bodied insects.

23. The method of claim 21 wherein the fungus culture is dispersed into the drain as a spray.

24. The method of claim 21 wherein the fungus culture is introduced as a powder into the drain.

25. The method of claim 21 wherein the fungus culture is introduced as a liquid into the drain.

26. The method of claim 21 wherein the fungus culture is introduced as a foam into the drain.

27. The method of claim 21 wherein the fungus culture is Metarhizium.
